(19) United States
(12) Patent Application Publication
(10) Pub. No.: US 2022/0215134 A1
(43) Pub. Date: Jul. 7, 2022

(54) ESTIMATING GENERATION CAPABILITY ASSOCIATED WITH A BUILDING DESIGN USING DIGITAL REPLICAS

(71) Applicant: International Business Machines Corporation, Armonk, NY (US)

(72) Inventors: Venkata Vara Prasad Karri, Visakhapatnam (IN); Sarbajit K. Rakshit, Kolkata (IN); Saraswathi Sailaja Perumalla, Visakhapatnam (IN); Surya Chandra Rao Jvvnn Kandregula, Visakhapatnam (IN)

(21) Appl. No.: 17/141,257

(22) Filed: Jan. 5, 2021

(51) Int. Cl. G06F 30/13; G06F 30/20

(52) U.S. Cl. CPC G06F 30/13; G06F 30/20

(57) ABSTRACT

Methods, computer program products, and/or systems are provided that perform the following operations: obtaining initial design data associated with a building; obtaining geolocation data associated with the building; obtaining environmental data associated with a location based on the geolocation data; simulating the building in an environment using one or more digital replica models, wherein the simulating of the building is based, at least in part, on the initial design data, the geolocation data, and the environmental data; and generating estimates for power generation capability associated with the building based in part on the simulation of the building in the environment.

### BACKGROUND

The present invention relates generally to the field of digital modeling, and more particularly to providing for the utilization of digital replica (e.g., “digital twin”) modeling in simulating a building to estimate generation capability associated with the building design.

A digital twin provides an exact virtual/digital replica of a physical entity (e.g., machine, product, system, process, service, and/or the like) creating a link between the physical and digital worlds. A digital twin can enable simulation, testing, modeling, analysis, and/or monitoring based on data generated by and/or collected from the digital twin.

### SUMMARY

According to an aspect of the present invention, there is a method, computer program product and/or system that performs the following operations (not necessarily in the following order): obtaining initial design data associated with a building; obtaining geolocation data associated with the building; obtaining environmental data associated with a location based on the geolocation data; simulating the building in an environment using one or more digital replica models, wherein the simulating of the building is based, at least in part, on the initial design data, the geolocation data, and the environmental data; and generating estimates for power generation capability associated with the building based in part on the simulation of the building in the environment.

### BRIEF DESCRIPTION OF THE DRAWINGS

FIG. 1 is a block diagram view of a first embodiment of a system, according to the present invention;

FIG. 2 is a flowchart showing a first embodiment method performed, at least in part, by the first embodiment system; and

FIG. 3 is a block diagram showing an example machine logic (for example, software) portion of the first embodiment system.

### DETAILED DESCRIPTION

According to aspects of the present disclosure, systems and methods can be provided to utilize digital replicas (e.g., digital twins) for simulation(s) of a building design (e.g., new building, building modification, etc.) and determine estimated power generation capabilities based on the building design. A digital replica (e.g., digital twin) provides a virtual/digital replica or representation of a physical entity (e.g., machine, product, system, process, service, and/or the like) creating a link between the physical and digital worlds. Digital replicas (e.g., digital twins) can enable modeling, simulations, testing, monitoring, and/or the like of such entities. The use of digital replicas (e.g., digital twins) can allow for simulating a design (e.g., building design, etc.) before it is physically constructed and aid understanding of how the design (e.g., building, etc.) will work, react, and/or the like when the design (e.g., building, etc.) is physically constructed. Such design simulation(s) can allow for recommending corrective actions during the design phase rather than during/after physical construction.

In particular, systems and methods of the present disclosure can provide for using digital replica(s) along with geolocation data, environmental data, and/or the like to simulate a building design (e.g., a smart building, etc.) in a particular location and/or environment, for example, prior to physical construction of a new building, physical building modification(s), and/or the like. The systems and methods of the present disclosure can provide for generating renewable power capability estimates associated with the building (e.g., building design), for example, renewable power generation capabilities using airflows, solar energy, exhaust gases, and/or the like, based on the building simulation(s). In some embodiments, the systems and methods of the present disclosure can provide for identifying and/or generating one or more recommendations for building design modifications, for example, to improve power generation capabilities, to address building cooling requirements, and/or the like, based on the digital replica building simulation(s).

Renewable power generation may be a factor considered in new building design (e.g., new building construction, building renovation, etc.) such that some portion of future energy needs at the building may be met by renewable power generation capabilities associated with the building (e.g., self-power generation through airflows, solar collection, etc.). For example, renewable power generation sources can include airflows through the building, sunlight received at/inside the building, exhaust gases from the building, and/or the like. The renewable power generation capability of a building (e.g., smart building, etc.) can be dependent on how the building is designed such as, for example, how airflow inside the building moves through passages, rooms, openings, and/or the like. As another example, the building design can affect the position and/or amount of sunlight that may be received at and/or enter the building throughout the day, thereby affecting solar energy collection for renewable power generation, affecting building cooling and/or heating, and/or the like.

Accordingly, systems and methods of the present disclosure, a building design can be simulated using digital replicas to estimate power generation capabilities and make design recommendations, for example, to maximize airflows, maximize solar collection, apply natural cooling effects, and/or the like, and potentially increase power generation capabilities. Additionally, in some embodiments, the simulations and recommendations can identify building designs that can maximize the use of natural light (e.g., sunlight) and natural cooling (e.g., airflows designed using Venturi effect, etc.) in a new building.

This Detailed Description section is divided into the following sub-sections: The Hardware and Software Environment; Example Embodiments; Further Comments and/or Embodiments; and Definitions.

The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

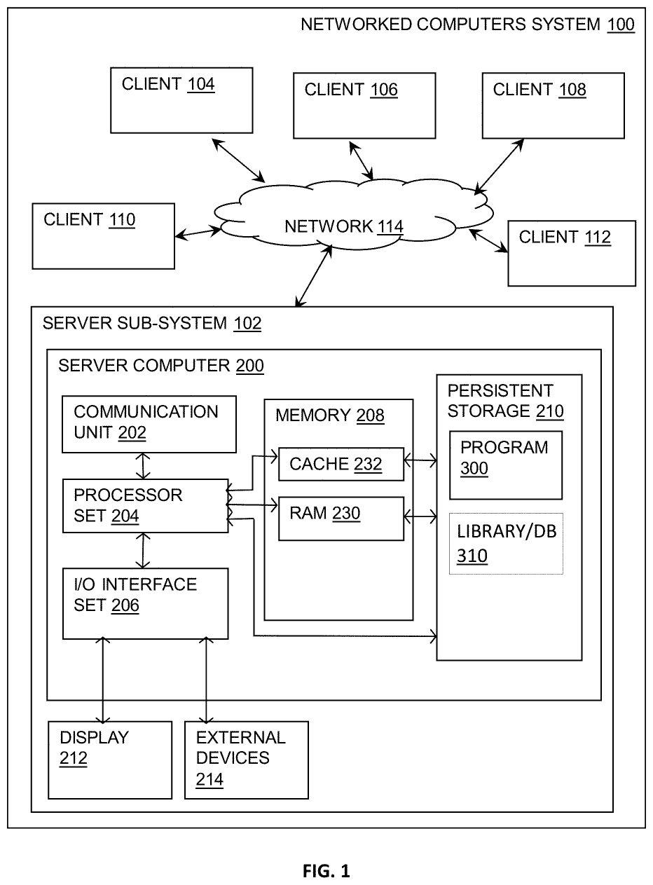

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine-readable instructions and/or data that can be used to create, manage, and control certain software functions, such as will be discussed in detail, below, in the Example Embodiment sub-section of this Detailed Description section. As an example, a program 300 can comprise generating digital replica (e.g., digital twin) simulations, generating power generation capacity estimates, identifying building design recommendations, and/or the like. In some embodiments, a library and/or database may be accessed by and/or included in, for example, server sub-system 102, server computer 200, and/or the like. The library and/or database (e.g., library 310) may include substantive data associated with a plurality of digital replicas (e.g., digital twin models) and may be accessed, for example by program 300, in utilizing (e.g., monitoring, controlling, generating data, analyzing, simulating, etc.) one or more digital replicas (e.g., digital twin models). Additionally and/or alternatively, a library 310 may include substantive data associated with building design requirements, building components, building structure, materials, historical design data, historical generation data, and/or the like and may be accessed, for example by program 300, in generating digital replica (e.g., digital twin) simulations, generating power generation capacity estimates, identifying building design recommendations, and/or the like, such as discussed herein.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). For example, program 300 may include machine readable and performable instructions to provide for performance of method operations as disclosed herein. In this particular embodiment, persistent storage 210 includes a magnetic hard disk drive. To name some possible variations, persistent storage 210 may include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor, a smart phone/tablet display screen, and/or the like.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Example Embodiments

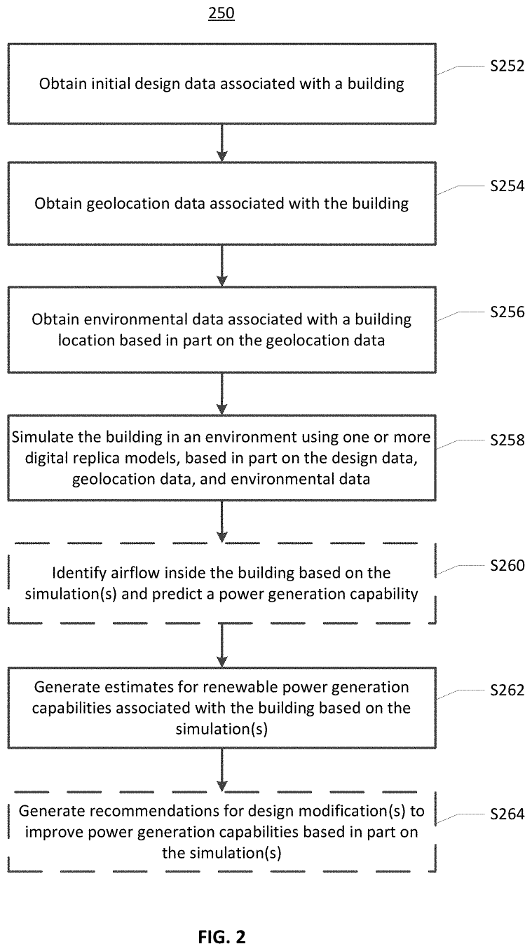

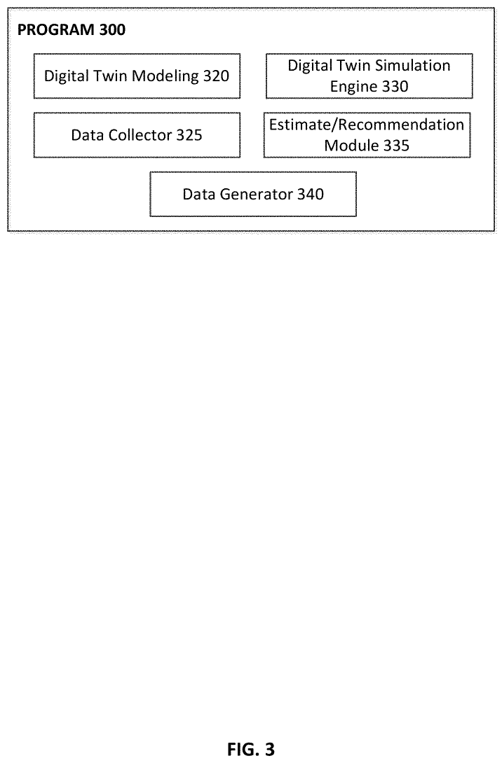

FIG. 2 shows flowchart 250 depicting a computer-implemented method, according to embodiment(s) of the present invention. FIG. 3 shows a program 300 for performing at least some of the method operations of flowchart 250. Regarding FIG. 2, one or more flowchart blocks may be identified with dashed lines and represent optional steps that may additionally be included, but which are not necessarily required, in the depicted embodiments. This method and associated software will now be discussed, over the course of the following paragraphs, with extensive reference to FIG. 2 (for the method operation blocks) and FIG. 3 (for the software blocks).

As illustrated in FIG. 2, in some embodiments, operations for estimating power generation capabilities associated with a building design (e.g., smart building, etc.) begin at operation S252, where a computing system (e.g., server computer 200 of FIG. 1 or the like) obtains initial design data associated with a building. In some embodiments, the initial design data can include one or more of position of the building, dimensions of the building (e.g., height, footprint, enclosed area/volume, etc.), openings in the building, passages/rooms in the building, roof shape/dimensions, building structural attributes, materials, and/or the like. In some embodiments, the computing system may also obtain desired ranges of power to be generated (e.g., from airflow, solar collection, etc.), desired amount of cooling to be performed inside the building, and/or the like. For example, a designer, user, etc. can define parameters regarding the desired amount of power generation capabilities, desired amount of cooling, and/or the like. The parameters for the desired amount of power generation capability, cooling, etc. can be analyzed and/or applied, for example, during simulation of the building (e.g., operation S258, etc.) and/or used in generating power generation capability estimates (e.g., operation S262, etc.) and/or design recommendations (e.g., operation S264, etc.).

As an example, a data collector module 325 of FIG. 3 and/or the like can provide for obtaining (e.g., from a designer, user, etc.) initial design data associated with a building project (e.g., new building, building renovation, etc.) including one or more of building position, building dimensions, building structural aspects, construction materials, openings, passages, rooms, and/or the like. In some embodiments, the data collector module 325 can also receive parameter data associated with desired aspects of a final building design, such as desired power generation capabilities, desired cooling performance, and/or the like.

Processing proceeds to operation S254, where the computing system (e.g., server computer 200 of FIG. 1 or the like) obtains geolocation data associated with the building. For example, the computing system can obtain geolocation data indicative of and/or associated with the location/site/property where the building is to be constructed. As an example, the data collector module 325 and/or the like can provide for obtaining geolocation data from a designer, user, stored data, and/or the like.

Processing proceeds to operation S256, where the computing system (e.g., server computer 200 of FIG. 1 or the like) obtains environmental data associated with the building. As an example, the environmental data may be obtained and/or determined based, at least in part, on the geolocation data associated with the building (e.g., building site, location, etc.). In some embodiments, the environmental data can include one or more of climate associated with the building location, weather conditions/patterns associated with the location, buildings and/or obstacles within a certain proximity, wind flow patterns/directions at various points of time, duration and/or direction of sunlight, and/or the like. As an example, the data collector module 325 and/or the like can provide for obtaining environmental data associated with the building and/or building location for one or more sources, such as other computing systems (or within the same computing system), databases, stored files, designers/users, third-party sources (e.g., weather services, mapping services, etc.), and/or the like.

Processing proceeds to operation S258, where the computing system (e.g., server computer 200 of FIG. 1 or the like) simulates the building in an environment (e.g., based on building site, location, etc.) using one or more digital replicas (e.g., digital twin models, etc.). The digital replica simulation(s) for the building in the environment can be generated based in part on the initial design data for the building, the geolocation data for the building, and/or the environmental data associated with the building and/or geolocation (e.g., building site, location, etc.). For example, in some embodiments, the computing system can obtain and/or generate one or more digital replicas (e.g., from a database, model library, etc.) and simulate the building design within an environment (e.g., at the site/location where the building is to be constructed, etc.). As an example, a digital twin modeling module 320 of FIG. 3 and/or the like may access a library, database, and/or the like (e.g., library/database 310 of FIG. 1, etc.) and obtain data for a digital replica (e.g., digital twin) simulation of the building design, for example, based at least in part on the initial design data for the building, the building geolocation data, the building/location environmental data, and/or the like. In some embodiments, the digital twin modeling module 320 and/or the like can provide data associated with one or more digital replicas (e.g., digital twins) to a digital twin simulation engine 330, and/or the like for use in simulating the building design within the desired environment (e.g., site, location, climate, etc.). In some embodiments, the digital replica simulation(s) can provide a wholistic understanding of the building design along with the building geolocation and environmental parameters (e.g., weather, climate, wind flow, sunlight direction/duration, nearby buildings/obstacles, etc.) to provide estimates of power generation capabilities (e.g., renewable power, etc.) associated with the building and/or recommendations for design modification(s), for example, to increase generation capabilities, building efficiency, and/or the like.

Optionally, in some embodiments, processing may continue to operation S260, where the computing system (e.g., server computer 200 of FIG. 1 or the like) can, as part of the digital replica simulation(s) of the building, identify one or more airflows inside/through the building and use the identified airflow(s) in predicting/estimating a power generation capability for the building based on the airflow(s). As an example, in some embodiments, the computing system can simulate the building in the desired environment (e.g., location, climate, etc.) and identify the environmental airflow (e.g., direction(s), velocity, volume(s), duration(s), etc.), the dimensions, position, and/or placement of passages, rooms, and/or openings of the building, the positions/dimensions of obstacles (e.g., internal structures, other buildings, natural features, other objects, etc. that may impact airflow, sunlight, etc.), the airflow dynamics and/or energy in different portions of the building, airflow exit speeds at one or more points of the building, and/or the like. The computing system can use this data (e.g., generated/obtained through the digital replica simulation(s)) to generate power generation capability estimates, building cooling potential estimates (e.g., temperature changes associated with the airflow(s)), and/or the like as part of simulating the building in the desired environment. In some embodiments, the digital replica simulation(s) of the building can simulate one or more airflow patterns inside the building, including speed and temperature of the air, to predict if the airflow speed is sufficient to provide power generation capabilities and if the airflow temperature (e.g., via Venturi effect, etc.) is such that the airflow can provide building cooling capacity. In some embodiments, based on data generated by the digital replica simulation(s) for the building in the environment, the computing system can identify modifications to increase or maximize the airflow inside a building, thereby increasing or maximizing the power generation capability.

Processing proceeds to operation S262, where the computing system (e.g., server computer 200 of FIG. 1 or the like) can generate one or more estimates for power generation capabilities associated with the building (e.g., building design, location, etc.) based on the digital replica simulation(s) of the building. As an example, an estimate/recommendation module 335 and/or the like can obtain data regarding the building simulation(s) (e.g., from a digital twin simulation engine 330, etc.) and identify and/or generate one or more estimates and/or predictions or power (e.g., renewable power, etc.) generation capabilities associated with the building in the defined environment. In some embodiments, the data generator module 340 and/or the like can generate and/or provide output associated with the generated estimates for power generation capabilities, for example, allowing for analysis of a building design, modification of building design elements, and/or the like.

For example, in some embodiments, the computing system can use data generated by and/or associated with the digital replica simulation(s) of the building to identify how building design choices, such as, for example, the design of building passages, ducts, rooms, and/or openings (e.g., dimensions, position, orientation, etc.), the roof shape and/or dimensions, the building construction materials, and/or the like, can affect power generation sources and use the simulation data to generate one or more estimates for power generation capabilities associated with the building.

As an example, in some embodiments, renewable power generation sources can include airflow through the building, exit airflow, incident/admitted sunlight, exhaust gases, and/or the like. Renewable power generation capabilities of a building, such as the airflow through a building, amount and/or duration of sunlight incident on and/or entering into a building, exhaust gases and/or exhaust heat captured, and/or the like, can be largely dependent on how a building is designed. The building geolocation (e.g., site/location where the building is constructed) and environmental parameters associated with the building location can also impact renewable power generation of the building. In one example, the digital replica simulation(s) of the building can identify how the dimensions, orientation, and/or the like of passages and openings within the building affect potential renewable power generation sources, for example affecting an airflow velocity or duration, an amount of sunlight incident on or entering into the building, building exhaust gases, and/or the like. In some embodiments, the computing system can use data associated with the design-related effects on the power generation sources, as well as other data associated with the simulation(s) to generate one or more estimates for power generation capabilities for the building.

In some embodiments, the computing system can access a historical knowledge corpus for use in simulating the building in the desired environment, generating estimates of power generation capabilities, and/or generation of recommendations associated with the building design (e.g., recommended changes to increase/maximize desired capabilities, etc.). In some embodiments, a historical knowledge corpus can include one or more of historical building designs; designer/user feedback; actual effects on power generation, sunlight, and/or building cooling, and/or the like.

Optionally, in some embodiments, processing may proceed to operation S264, where the computing system (e.g., server computer 200 of FIG. 1 or the like) can generate recommendations for changes, revisions, or modifications to the building design (e.g., elements of the building design, etc.) based, at least in part on the digital replica simulation(s) of the building design and the generated estimates for power generation capabilities. For example, in some embodiments, the computing system may identify and/or generate recommendations about changes to shape, dimensions, orientation, etc. of building passages and/or openings to modify airflow within the building, increase exit airflow speed, and/or the like, to provide improvements (e.g., increase, maximize, etc.) to desired power generation capabilities, building cooling effects, and or the like. In some embodiments, the digital replica simulation(s) of the building in the environment (e.g., building location, site, etc.) can provide a broader understanding of the effects of the building design on renewable power generation capabilities and provide for design recommendations (e.g., design element modifications, etc.) prior to physical construction of the building.

### Further Comments and/or Embodiments

In some embodiments, renewable power generation for a building can be provided based on aspects such as airflow inside the building with required velocity and duration, direction and duration of sunlight, exhaust system design, and/or the like, which may all be dependent on aspects of the building design. The building location and associated environmental parameters, such as, for example, weather, climate, obstacles in the surrounding area, wind flow direction at different points of time, sun position at different points of time, and/or the like, can also factor in with the building design in affecting the potential for renewable power generation capabilities of a building. According to aspects of the present disclosure, in some embodiments, the use of digital replica simulations for a building design can facilitate an understanding of the building along with its geo-position (e.g., location, site, etc.) and other associated environmental parameters such that a wholistic scenario can be considered while designing any smart building.

In some embodiments, digital replicas can be used in simulating a smart building to determine power generation capabilities associated with the building design prior to any physical construction, such as, for example, identifying how airflow(s) inside the building can be used for power generation, as well as how power may be generated based on solar power and/or exhaust air. Additionally, the digital replica simulation(s) may provide for identifying natural cooling capacity (e.g., Venturi effect, etc.) and increasing or maximizing use of natural light such that power consumption may be reduced.

In some embodiments, the computing system may also access or obtain existing building blueprint images (e.g., post construction, etc.) to identify current structural compositions, the contour area of the building and/or the like to generate recommendations for improved airflow, more effective use of sunlight, and or the like for the building.

In some embodiments, the computing system obtain the geolocation of the building and identify the relative direction of the sun at different times, the position and/or intensity of sunlight falling on or entering into the building at different times, the shape and dimensions of the roof and walls, the space around the building, and/or the like for use in simulating the building and/or generating design recommendations for increasing use of sunlight and/or reflected sunlight, for example, in renewable power generation and/or building lighting. In some embodiments, the computing system may use a historical knowledge corpus in identifying building positions, orientations, and/or the like to increase or maximize the amount of sunlight received. In some embodiments, the computing system may identify, for example, as part of simulating the building, how reflectors can be arranged so that sunlight may be reflected inside the building to increase the received sunlight in the building.

In some embodiments, the computing system may, as part of simulating the building design, identify potential energy/heat radiation generated by devices that may be present in a building (e.g., based on planned building use, etc.) and identify suggestions for capturing and/or reusing such energy/heat radiation.

In some embodiments, the computing system may, as part of simulating the building design, identify potential locations where undesired light rays from the sun and/or atmospheric gasses may be present and provide recommendations for design modifications (e.g., at the potential locations, etc.) to address such issues.

### Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
obtaining initial design data associated with a building;
obtaining geolocation data associated with the building;
obtaining environmental data associated with a location based on the geolocation data;
simulating the building in an environment using one or more digital replica models, wherein the simulating of the building is based, at least in part, on the initial design data, the geolocation data, and the environmental data; and
generating estimates for power generation capability associated with the building based in part on the simulation of the building in the environment.

2. The computer-implemented method of claim 1, further comprising:
generating one or more recommendations for modifying a building design based, at least in part, on the simulation of the building, wherein the recommendations provide an estimated increase of the power generation capability associated with the building.

3. The computer-implemented method of claim 1, wherein simulating the building in the environment comprises:
simulating an airflow pattern inside the building; and
predicting a power generation capability based on air velocity associated with the airflow pattern inside the building.

4. The computer-implemented method of claim 3, further comprising predicting a cooling capacity based on an air temperature associated with the airflow pattern.

5. The computer-implemented method of claim 1, wherein simulating the building in the environment includes identifying dimensions and positions of passages inside the building, rooms inside the building, and openings associated with the building.

6. The computer-implemented method of claim 1, further comprising:
identifying one or more obstacles within a defined proximity to the building, based at least in part, on the geolocation data associated with the building; and
wherein simulating the building in the environment is further based on the one or more obstacles.

7. The computer-implemented method of claim 1, further comprising:
obtaining a historical knowledge corpus; and
applying data from the historical knowledge corpus in simulating the building in the environment.

8. The computer-implemented method of claim 1, further comprising:
identifying a position and an amount of sunlight received at the building throughout a day; and
applying the position and the amount of sunlight identified as part of simulating the building in the environment.

9. A computer program product comprising a computer readable storage medium having stored thereon:
program instructions programmed to obtain initial design data associated with a building;
program instructions programmed to obtain geolocation data associated with the building;
program instructions programmed to obtain environmental data associated with a location based on the geolocation data;
program instructions programmed to simulate the building in an environment using one or more digital replica models, wherein the simulating of the building is based, at least in part, on the initial design data, the geolocation data, and the environmental data; and
program instructions programmed to generate estimates for power generation capability associated with the building based in part on the simulation of the building in the environment.

10. The computer program product of claim 9, the computer readable storage medium having further stored thereon:
program instructions programmed to generate one or more recommendations for modifying a building design based, at least in part, on the simulation of the building, wherein the recommendations provide an estimated increase of the power generation capability associated with the building.

11. The computer program product of claim 9, wherein simulating the building in the environment comprises:
simulating an airflow pattern inside the building; and
predicting a power generation capability based on air velocity associated with the airflow pattern inside the building.

12. The computer program product of claim 11, the computer readable storage medium having further stored thereon:
program instructions programmed to predict a cooling capacity based on an air temperature associated with the airflow pattern.

13. The computer program product of claim 9, wherein simulating the building in the environment includes identifying dimensions and positions of passages inside the building, rooms inside the building, and openings associated with the building.

14. The computer program product of claim 9, the computer readable storage medium having further stored thereon:
program instructions programmed to identify one or more obstacles within a defined proximity to the building, based at least in part, on the geolocation data associated with the building; and
wherein simulating the building in the environment is further based on the one or more obstacles.

15. The computer program product of claim 9, the computer readable storage medium having further stored thereon:
program instructions programmed to obtain a historical knowledge corpus; and
program instructions programmed to apply data from the historical knowledge corpus in simulating the building in the environment.

16. The computer program product of claim 9, the computer readable storage medium having further stored thereon:
program instructions programmed to identify a position and amount of sunlight received at the building throughout a day; and
program instructions programmed to apply the position and amount of sunlight identified as part of simulating the building in the environment.

17. A computer system comprising:
a processor set; and
a computer readable storage medium;
wherein:
the processor set is structured, located, connected and programmed to run program instructions stored on the computer readable storage medium; and
the stored program instructions include:
program instructions programmed to obtain initial design data associated with a building;
program instructions programmed to obtain geolocation data associated with the building;
program instructions programmed to obtain environmental data associated with a location based on the geolocation data;
program instructions programmed to simulate the building in an environment using one or more digital replica models, wherein the simulating of the building is based, at least in part, on the initial design data, the geolocation data, and the environmental data; and
program instructions programmed to generate estimates for power generation capability associated with the building based in part on the simulation of the building in the environment.

18. The computer system of claim 17, wherein the stored program instructions further include:
program instructions programmed to generate one or more recommendations for modifying a building design based, at least in part, on the simulation of the building, wherein the recommendations provide an estimated increase of the power generation capability associated with the building.

19. The computer system of claim 17, wherein simulating the building in the environment comprises:
simulating an airflow pattern inside the building; and
predicting a power generation capability based on air velocity associated with the airflow pattern inside the building.

20. The computer system of claim 17, wherein the stored program instructions further include:
program instructions programmed to obtain a historical knowledge corpus; and
program instructions programmed to apply data from the historical knowledge corpus in simulating the building in the environment.
